(19) United States
(12) Patent Application Publication
(10) Pub. No.: US 2016/0242153 A1
(43) Pub. Date: Aug. 18, 2016

(54) EIMTA IN ENHANCED CARRIER AGGREGATION

(71) Applicant: QUALCOMM Incorporated, San Diego, CA (US)

(72) Inventors: Wanshi CHEN, San Diego, CA (US); Jelena DAMNJANOVIC, Del Mar, CA (US); Peter GAAL, San Diego, CA (US)

(21) Appl. No.: 15/042,025

(22) Filed: Feb. 11, 2016

Related U.S. Application Data
(60) Provisional application No. 62/116,338, filed on Feb. 13, 2015.

(51) Int. Cl. H04W 72/04; H04L 5/00; H04W 72/12; H04L 5/14

(52) U.S. Cl. CPC H04W 72/042; H04L 5/1476; H04L 5/0098; H04W 72/1263

(57) ABSTRACT

The disclosure provides techniques for signaling TDD configurations with downlink control information (DCI). A user equipment receives DCI, and determines a first portion of the DCI corresponding to a first TDD uplink-downlink configuration for a first group of component carriers (CCs) of a plurality of carrier groups and a second portion of the DCI corresponding to a second TDD uplink-downlink configuration for a second group of CCs of the plurality of carrier groups, where a bit length of the first portion is different from a bit length of the second portion. The UE determines the first TDD uplink-downlink configuration based on the first portion and the second TDD uplink-downlink configuration based on the second portion, where each of the first and second uplink-downlink configurations corresponds to an available TDD uplink-downlink configuration for carriers in a respective group of CCs.

### CROSS-REFERENCE TO RELATED APPLICATION(S)

This application claims the benefit of U.S. Provisional Application Ser. No. 62/116,338, entitled “EIMTA IN ENHANCED CARRIER AGGREGATION” and filed on Feb. 13, 2015, which is expressly incorporated by reference herein in its entirety.

### BACKGROUND

1. Field

The present disclosure relates generally to communication systems, and more particularly, to indicating uplink-downlink configurations for evolved Interference Mitigation and Traffic Adaptation (eIMTA).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

With improvements in the technology, a user equipment may be configured with more component carriers. For a particular band with which one or more component carriers are associated, a user equipment is configured with an uplink-downlink configuration. Although more indicators may be needed to indicate uplink-downlink configurations for more component carriers, a size of data for such indicators is often limited.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A number of available bits in downlink control information (DCI) for indicating time division duplex (TDD) uplink-downlink configurations for different groups of CCs is generally limited. Therefore, generally, a limited number of TDD uplink-downlink configurations may be indicated by the available bits in the DCI payload. The disclosure provides a way to improve the use of the number of bits in the DCI such that more TDD configurations can be indicated by the limited number of bits. For example, different bit lengths may be used to indicate TDD uplink-downlink configurations for different groups of CCs, such that the use of the number of bits in the DCI may be maximized.

In an aspect of the disclosure, a method, a computer-readable medium, and an apparatus are provided. The apparatus may be a user equipment (UE). The UE receives downlink control information (DCI). The UE determines a first portion of the DCI corresponding to a first time division duplex (TDD) uplink-downlink configuration for a first group of component carriers (CCs) of a plurality of carrier groups and a second portion of the DCI corresponding to a second TDD uplink-downlink configuration for a second group of CCs of the plurality of carrier groups, where a bit length of the first portion is different from a bit length of the second portion. The UE determines the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs.

In another aspect of the disclosure, the apparatus may be a UE. The UE includes means for receiving DCI. The UE includes means for determining a first portion of the DCI corresponding to a TDD uplink-downlink configuration for a first group of CCs of a plurality of carrier groups and a second portion of the DCI corresponding to a second TDD uplink-downlink configuration for a second group of CCs of the plurality of carrier groups, where a bit length of the first portion is different from a bit length of the second portion. The UE includes means for determining the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs.

In another aspect of the disclosure, the apparatus may be a UE including a memory and at least one processor coupled to the memory. The at least one processor is configured to: receive DCI, determine a first portion of the DCI corresponding to a TDD uplink-downlink configuration for a first group of CCs of a plurality of carrier groups and a second portion of the DCI corresponding to a second TDD uplink-downlink configuration for a second group of CCs of the plurality of carrier groups, where a bit length of the first portion is different from a bit length of the second portion, and determines the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs.

In another aspect of the disclosure, a computer-readable medium storing computer executable code for a UE comprises code to: receive DCI, determine a first portion of the DCI corresponding to a TDD uplink-downlink configuration for a first group of CCs of a plurality of carrier groups and a second portion of the DCI corresponding to a second TDD uplink-downlink configuration for a second group of CCs of the plurality of carrier groups, where a bit length of the first portion is different from a bit length of the second portion, and determines the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs.

In an aspect of the disclosure, a method, a computer-readable medium, and an apparatus are provided. The apparatus may be a base station. The base station configures DC) to include a first portion of the DCI corresponding to a first TDD uplink-downlink configuration for a first group of CCs of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs. The base station transmits the DCI to a UE.

In another aspect of the disclosure, the apparatus may be a UE. The UE includes means for configuring DCI to include a first portion of the DCI corresponding to a first TDD uplink-downlink configuration for a first group of CCs of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs. The UE includes means for transmitting the DCI to a UE.

In another aspect of the disclosure, the apparatus may be a UE including a memory and at least one processor coupled to the memory. The at least one processor is configured to: configure DCI to include a first portion of the DCI corresponding to a first TDD uplink-downlink configuration for a first group of CCs of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs, and transmit the DCI to a UE.

In another aspect of the disclosure, a computer-readable medium storing computer executable code for a base station comprises code to: configure DCI to include a first portion of the DCI corresponding to a first TDD uplink-downlink configuration for a first group of CCs of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs, and transmit the DCI to a UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4 discloses MAC layer data aggregation.

FIG. 5A is a diagram illustrating an example of continuous carrier aggregation.

FIG. 5B is a diagram illustrating an example of non-continuous carrier aggregation.

FIG. 6 illustrates a frame structure corresponding to a switch-point periodicity of 5 msec.

FIG. 7 is a flow chart of a method of wireless communication.

FIG. 8 is a flowchart of a method of wireless communication, expanding from the flowchart of FIG. 7

FIG. 9 is a conceptual data flow diagram illustrating the data flow between different means/components in an exemplary apparatus.

FIG. 10 is a diagram illustrating an example of a hardware implementation for an apparatus employing a processing system.

FIG. 11 is a flow chart of a method of wireless communication.

FIG. 12 is a conceptual data flow diagram illustrating the data flow between different means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

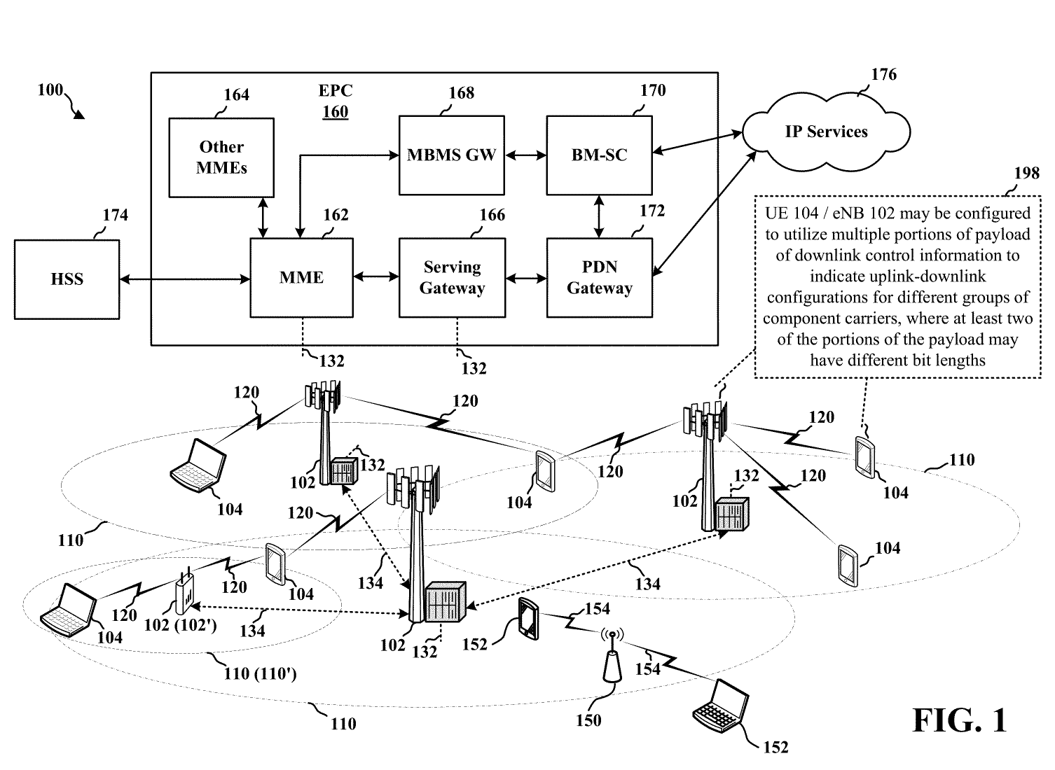

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., 51 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104/eNB 102 may be configured to utilize multiple portions of payload of downlink control information to indicate uplink-downlink configurations for different groups of component carriers, where at least two of the portions of the payload may have different bit lengths (198).

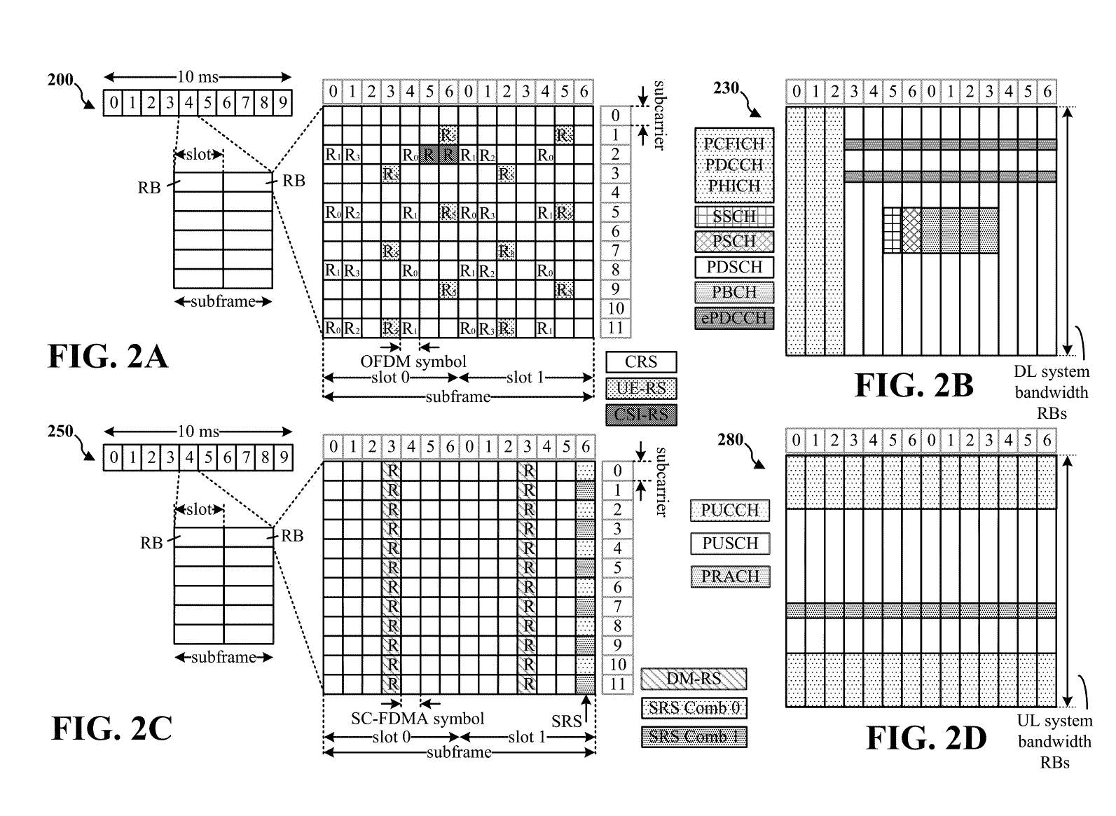

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (HACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3, of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

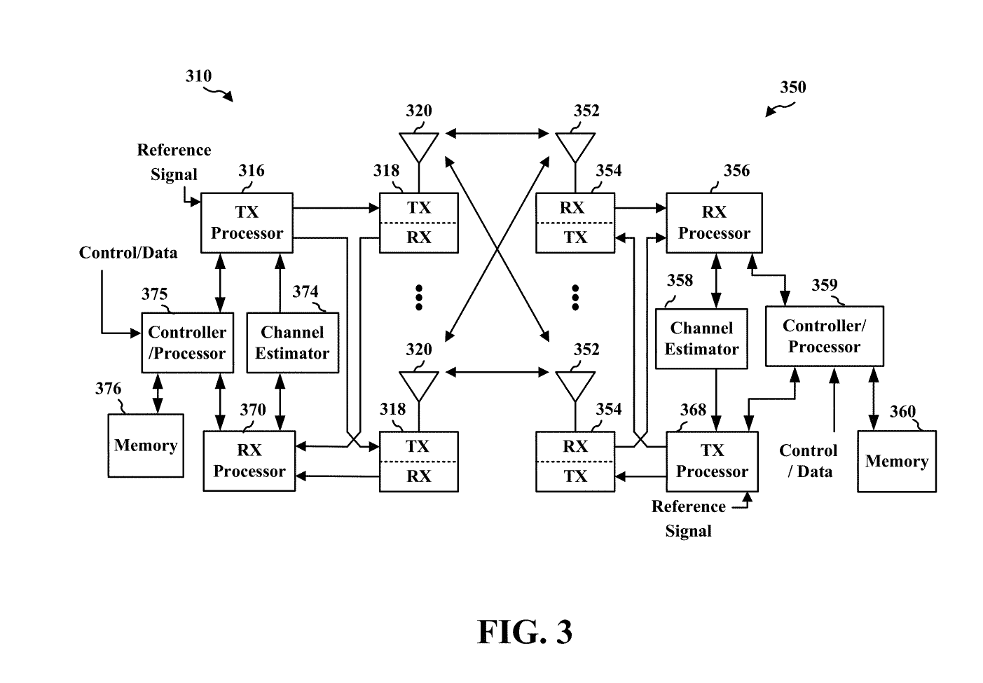

FIG. 3 is a block diagram of an eNB 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the eNB 310, the controller/processor 359 provides RRC layer functionality associated with system information (e.g., MIB, SIBS) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

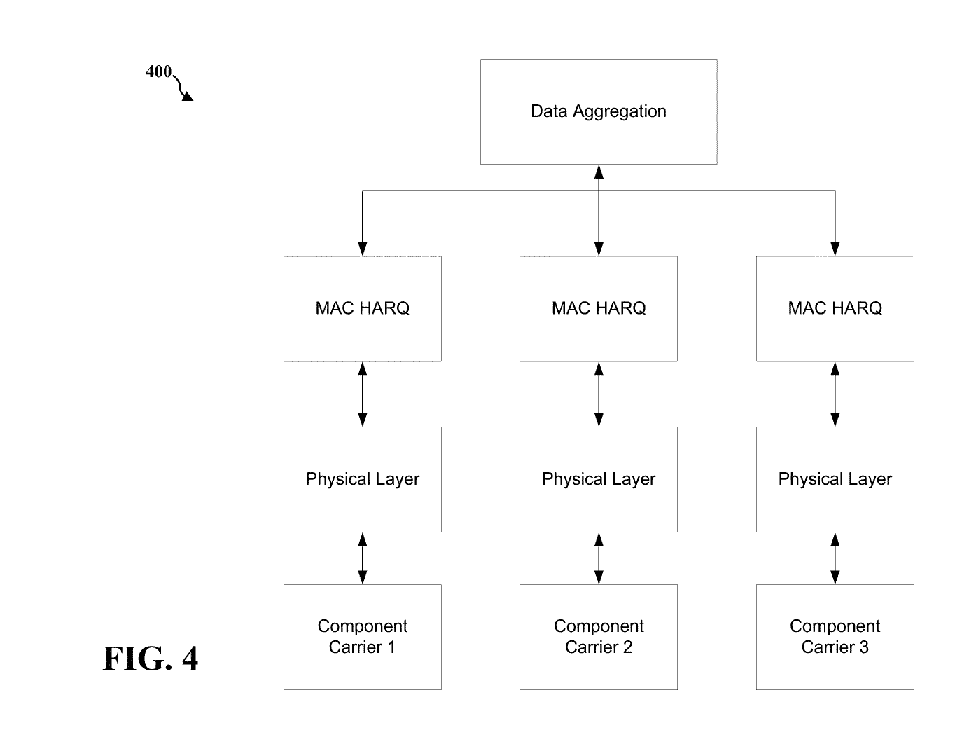

FIG. 4 illustrates aggregating transmission blocks (TBs) from different component carriers at the medium access control (MAC) layer. With MAC layer data aggregation, each component carrier has its own independent hybrid automatic repeat request (HARQ) entity in the MAC layer and its own transmission configuration parameters (e.g., transmitting power, modulation and coding schemes, and multiple antenna configuration) in the physical layer. Similarly, in the physical layer, one HARQ entity is provided for each component carrier.

### Carrier Aggregation

UEs may use spectrum up to 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 Mhz. These asymmetric frequency division duplex (FDD) assignments conserve spectrum and are a good fit for the typically asymmetric bandwidth utilization by broadband subscribers.

### Carrier Aggregation Types

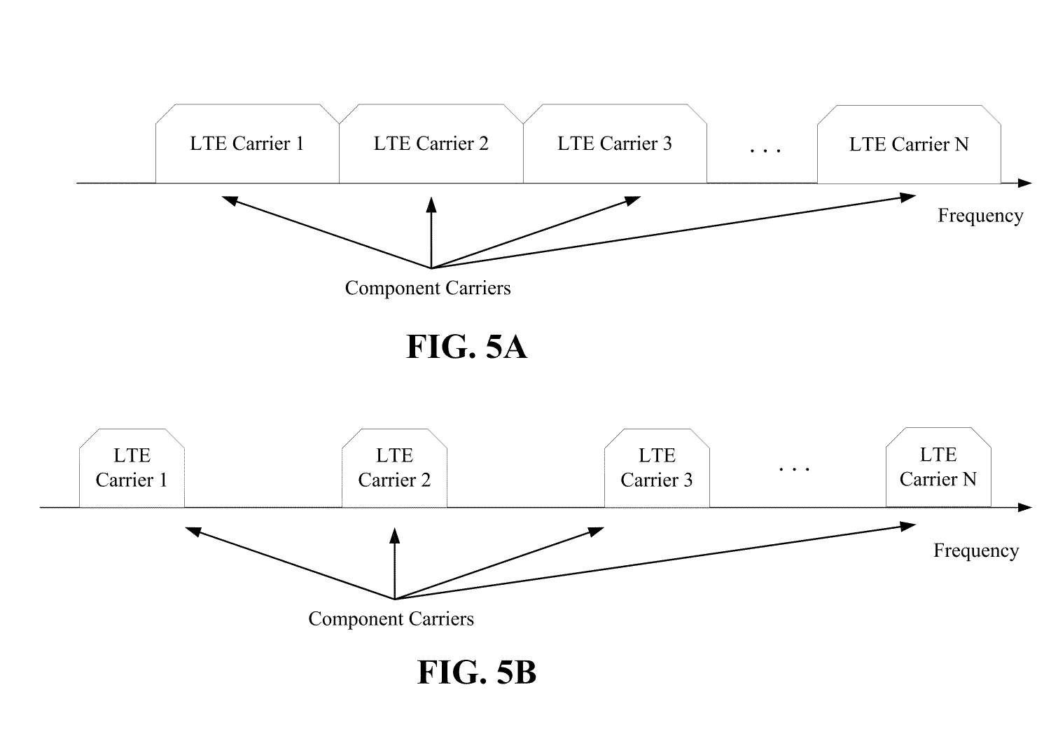

Two types of carrier aggregation (CA) methods have been proposed, continuous CA and non-continuous CA. The two types of CA methods are illustrated in FIGS. 5A and 5B. Non-continuous CA occurs when multiple available component carriers are separated along the frequency band (FIG. 5B). On the other hand, continuous CA occurs when multiple available component carriers are adjacent to each other (FIG. 5A). Both non-continuous and continuous CA aggregates multiple LTE/component carriers to serve a single UE.

In one aspect of carrier aggregation (CA), a UE may be configured with up to 5 component carriers (CCs). Each of the CCs may be backward compatible. As discussed supra, a base station and a UE may use a bandwidth up to 20 MHz per CC allocated in CA. If the UE can be configured with up to 5 CCs in CA, up to 100 MHz can be configured for the UE.

The aggregated CCs may be all configured for FDD, or may be all configured for time division duplex (TDD). Alternatively, the aggregated CCs may be a mixture (e.g., combination) of at least one CC configured for FDD and at least one CC configured for TDD. Different CCs configured for TDD may have the same or different DL/UL configurations. In a DL/UL configuration, each subframe may be reserved for a DL communication, or for a UL communication, or as a special subframe. Special subframes may be configured differently for different CCs configured for TDD.

Among the aggregated CCs, one CC is configured as the primary CC (PCC) for the UE and other CCs are referred to as secondary CCs (SCCs). The PCC is the only CC that carries a PUCCH and a common search space (CSS) for the UE.

A PUCCH may be enabled on two CCs in CA for a UE. For example, in addition to the PCC carrying a PUCCH, one SCC may carry a PUCCH as well. Utilizing two CCs in CA to carry PUCCH may help to address, for example, dual-connectivity and PUCCH load balancing needs.

In some cases, cells (CCs) may not have ideal backhaul (e.g., connections between eNBs), and, consequently, proper coordination between the cells may not be possible due to limited backhaul capacity and non-negligible backhaul latency (tens of milliseconds). Dual-connectivity that enables a UE may be simultaneously connected to two nodes (e.g., eNBs) addresses these issues.

In dual-connectivity, cells are partitioned into two groups. The two groups are a primary cell group (PCG) and a secondary cell group (SCG). Each group may have one or more cells in CA. Each group has a single cell that carries a PUCCH. In the PCG, a primary cell (e.g., PCC) carries a PUCCH for the PCG. In the SCG, a secondary cell (e.g., SCC) carries a PUCCH for the SCG. This secondary cell may be referred to also as the pScell.

Uplink control information (UCI) is separately conveyed to each group via the PUCCH in each group. A common search space is also additionally monitored in the SCG by a UE. Semi-persistent scheduling (SPS) (or semi-static scheduling) and scheduling request (SR) are supported in the SCG as well.

There is a need for increasing the number of CCs beyond five to provide higher bandwidth and increased data rates. Thus, a carrier aggregation approach with more than five CCs has been introduced. This approach may be referred to herein as enhanced CA, according to which a UE may be configured with more than five CCs (e.g., between six and 32 CCs) for CA. Enhanced CA may require development of physical layer specifications for PUCCH on SCell, and mechanisms to enable LTE CA for an increased number of CCs for the DL and the UL, e.g., 32 CCs for the DL and the UL may be specified. The mechanisms may include enhancements to DL control signaling for the increased number of CCs, possibly including both self-scheduling and cross-carrier scheduling. The mechanisms may include enhancements to UL control signaling for the number of CCs greater than five. These enhancements may include enhancements to support UCI feedback on the PUCCH for the increased number of DL carriers. For example, the enhancements may relate to UCI signaling formats that are necessary to support UCI feedback for more than five DL carriers. The mechanisms may also include enhancements to support UCI feedback on the PUSCH for more than five DL carriers.

As noted earlier, both FDD and TDD are supported in LTE applications. For example, both FDD and TDD frame structures are supported. With respect to TDD, a particular number of UL-DL configurations (e.g., UL-DL subframe configurations) may be supported. For example, with reference to TABLE 1 below, up to seven TDD UL-DL configurations (TDD configurations) may be supported.

TABLE 1
Uplink-downlink configurations.

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

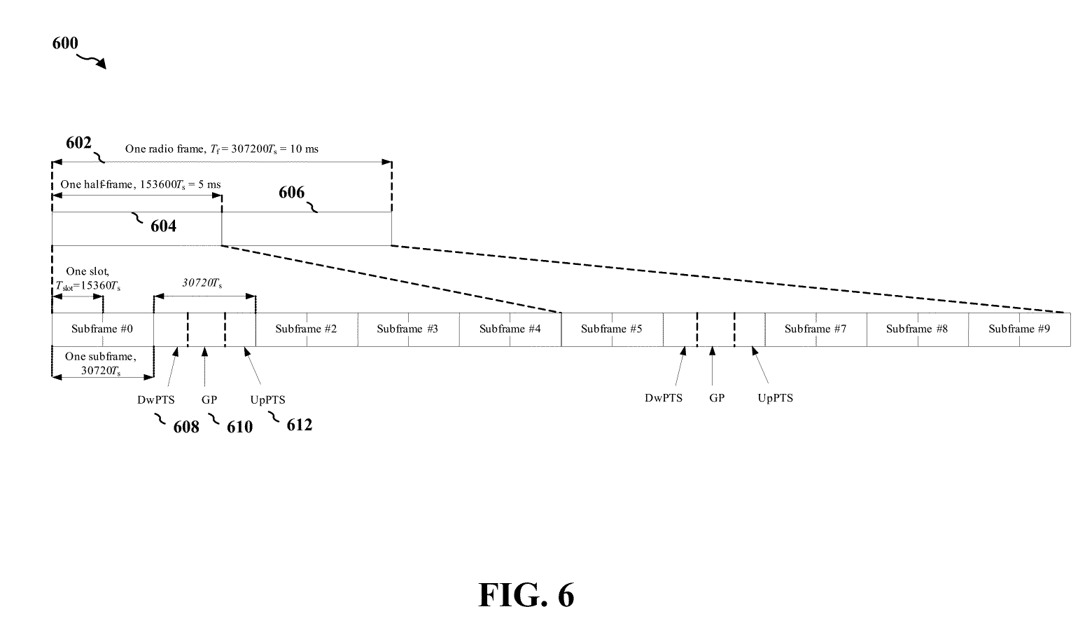

In TABLE 1, the indices 0, 1, 2, 3, 4, 5, 6 correspond to respective supported UL-DL configurations. In each configuration, ‘D’ indicates that a particular subframe of a radio frame is reserved for DL transmissions, and ‘U’ indicates that a particular subframe is reserved for UL transmissions. ‘S’ indicates that a particular subframe is a special subframe. The special subframe has three fields: DL Pilot Time Slot (DwPTS), guard period (GP), and UL Pilot Time Slot (UpPTS). These three fields will be described in more detail later with reference to FIG. 6.

With reference to TABLE 1, the indices 0, 1, 2, and 6 correspond to configurations having a switch-point periodicity of 5 msec. In these configurations, there are two special subframes in a 10-msec frame. One special subframe is in subframe 1 (in a first half-frame), and another special subframe is in subframe 6 (in a second half-frame). The indices 3, 4, and 5 correspond to configurations having a switch-point periodicity of 10 msec. In these configurations, there is only one special subframe in a 10-msec frame. The special subframe is in subframe 1 (in the first half-frame).

FIG. 6 illustrates a frame structure 600 corresponding to a switch-point periodicity of 5 msec.

The radio frame 602 has a length of 10 msec and includes half-frames 604 and 606. Each of the half-frames 604 and 606 has a length of 5 msec. Each of the half-frames 604 and 606 is composed of five subframes. For example, the half-frame 604 is composed of subframes 0, 1, 2, 3, and 4, and the half-frame 606 is composed of subframes 5, 6, 7, 8, and 9. With reference back to TABLE 1, subframes 0 and 5 are always reserved for DL transmission. In addition, subframe 1 is always a special subframe. With reference to FIG. 6, subframe 1 is composed of a downlink pilot time slot (DwPTS) 608, a guard period (GP 610), and an uplink pilot time slot (UpPTS) 612.

According to evolved Interference Management for Traffic Adaptation (eIMTA), TDD UL-DL configurations may be dynamically adapted based on actual traffic needs. For example, a TDD UL-DL configuration may be changed from one configuration to another, in order to allocate a larger/smaller number of subframes for DL (or for UL). Thus, if DL traffic needs are greater than UL traffic needs, a TDD UL-DL configuration may be set to a configuration that includes a large number of DL subframes. On the other hand, if UL traffic needs are greater than DL traffic needs, a TDD UL-DL configuration may be set to a configuration that includes a large number of UL subframes. For example, in order to facilitate transmission of a DL data burst, a TDD UL-DL configuration may be changed from configuration 1 to a configuration that includes a larger number of subframes for DL (e.g., configuration 5). With reference back to TABLE 1, configuration 1 includes six subframes for downlink (subframes 0, 4, 5 and 9, as well as special subframes 1 and 6). Configuration 5 includes nine subframes for downlink (subframes 0, 3, 4, 5, 6, 7, 8, and 9, as well as special subframe 1). The adaptation of TDD configuration can be performed as quickly as 10 msec.

The TDD UL-DL configuration that is to be used may be dynamically indicated by explicit signaling (e.g., layer 1 signaling). For example, the signaling may indicate reconfiguration by a UE-group-common PDCCH via DCI format 1C scrambled by an eIMTA-Radio Network Temporary Identifier (RNTI) in a CSS. In particular, the UE may receive the DCI format 1C (e.g., from an eNB), and may perform TDD UL-DL configurations based on the indication provided in the DCI format 1C.

The indication for the TDD UL-DL configuration may be achieved via a 3-bit indicator. Because a 3-bit indicator has eight possible values, the three-bit indicator is sufficiently long to indicate seven configurations (e.g., up to seven TDD UL-DL configurations listed in TABLE 1). The DCI format 1C may carry one or more 3-bit indicators to the UE.

In the case of carrier aggregation, CCs that belong to a same group belong to a same band. Also, each group of CCs is in a different band. CCs that belong to a same band (e.g., a same operating frequency band, or a same operating spectrum) may be subject to a same TDD UL-DL configuration. Therefore, CCs that belong to a same band may be associated with a same indicator for the same TDD UL-DL configuration. Examples of individual frequency bands include LTE, LTE-Unlicensed (LTE-U), etc. LTE frequency bands may be at 700 MHz or 2 GHz. LTE-U frequency bands may be at 2.4 GHz or 5 GHz.

The size of the DCI format 1C (e.g., the size of a corresponding payload) may depend on (e.g., increase with) system bandwidth. In particular, the size of the DCI format 1C may be larger for a larger system bandwidth. For example, for a system bandwidth of 1.4 MHz, the size of the DCI format 1C payload is 8 bits (e.g., before 16-bit CRC). For a system bandwidth of 20 MHz, the size of the DCI format 1C payload is 15 bits.

In carrier aggregation, a UE monitors a CSS only on the Pcell. As noted above, for a system bandwidth of 20 MHz, the size of the DCI format 1C payload is 15 bits. Therefore, the payload of the DCI format 1C can carry up to five 3-bit indicators. Accordingly, the payload can indicate the TDD UL-DL configurations for up to 5 CCs per UE. More precisely, the payload can indicate the TDD UL-DL configurations for up to 5 groups of CCs, if the CCs in a given group are associated with a same band.

In dual-connectivity, the UE monitors the CSS on both the Pcell and the pScell. Therefore, for a system bandwidth of 20 MHz, the DCI format 1C payloads corresponding to the Pcell and the pScell can, in theory, collectively indicate the TDD configurations for up to 10 groups of CCs per UE. In particular, the DCI format 1C payload corresponding to the Pcell in the PCG can, in theory, indicate the TDD configurations for up to five groups of CCs, and the DCI format 1C payload corresponding to the pScell in the SCG can, in theory, indicate the TDD configurations for up to five groups of CCs. Accordingly, up to 10 groups of CCs can be supported for eIMTA. However, if a UE cannot be configured with more than five CCs, it is possible that the DCI format 1C payload corresponding to the Pcell/pScell will not, in practice, be used to indicate the TDD configurations for up to five groups. Thus, in such a case, the DCI format 1C payload may indicate the TDD configurations for less than five groups of CCs. For example, if a UE is configured with five CCs, such that two CCs belong to one group and three CCs belong to another group, then the payload may be used to indicate the TDD configurations for only two groups.

In eIMTA, dynamic UL-DL configuration may have complexity in DL/UL Hybrid Automatic Repeat request (HARQ) management (e.g., due to the impact on a HARQ operation). To simplify the HARQ management, a reference DL/UL subframe configuration may be used. For example, for UL HARQ, scheduling and HARQ timing may be based on the DL/UL subframe configuration as indicated in System Information Block 1 (SIB1). For DL HARQ, a UE is configured with a reference configuration, where a configuration from among configuration 2, 4, or 5 (see TABLE 1) may be used as a reference configuration.

In eIMTA, some subframes may not be subject to dynamic adaptations of transmission directions. For example, in changing from one TDD configuration to another, particular subframes of a radio frame may not be changed from being for UL/DL to being for DL/UL. In contrast, other subframes may be subject to dynamic adaptations of transmission directions. For example, in changing from one TDD configuration to another, these other subframes may be changed from being for UL/DL to being for DL/UL. According to one general concept, subframes that are for DL in a TDD configuration indicated in SIB 1 may not be subject to dynamic adaptation. Also, subframes that are for UL in a reference configuration for DL HARQ may not be subject to dynamic adaptation. This concept will be described in more detail later with reference to various examples.

As described earlier, according to enhanced CA, a UE may be configured with more than five CCs (e.g., between six and 32 CCs) for CA. For example, a UE may be configured with 32 CCs. The 32 CCs may belong to more than five bands. In this situation, the UE is configured with more than five groups of CCs. As also described earlier, for a system bandwidth of 20 MHz, the payload corresponding to the Pcell can indicate the TDD configurations for up to five groups of CCs per UE. The size of the payload is reduced if the system bandwidth is less than 20 MHz. For example, if the system bandwidth is equal to 10 MHz, then the payload (e.g., a DCI format 1C payload) may be able to indicate the TDD configurations for only up to four groups. Therefore, the payload (e.g., a DCI format 1C payload) corresponding to the Pcell may not be sufficiently large to support situations in which a UE is configured with more than five CCs (e.g., between six and 32 CCs).

As also described earlier, for a system bandwidth of 20 MHz, the payloads corresponding to the Pcell and the pScell can, in theory, collectively indicate the TDD configurations for up to 10 groups of CCs per UE. The increase in the number of groups of CCs that can be supported (e.g., 10 groups rather than 5 groups) may be sufficient to support situations in which a UE is configured with more than five CCs (e.g., between six and 32 CCs). However, this approach requires that the UE perform additional CSS monitoring. For example, the UE is required to monitor not only the CSS on the Pcell but also the CSS on the sPcell.

According to aspects of the disclosure, indicators with different bit lengths may be included in the DCI (e.g., DCI format 1C) to indicate TDD configurations for an increased number of groups of CCs. When a UE is configured with multiple CCs, not all CCs are necessarily afforded the same level of flexibility with respect to eIMTA adaptation. In particular, for certain CCs, a TDD configuration may be selected from all seven possible TDD configurations, whereas for other CCs, a TDD configuration may be selected from less than seven possible TDD configurations. Thus, for example, in the DCI format 1C, although 3 bits may be used to indicate one of seven TDD configurations for a group of CCs, a different number of bits (e.g., less than 3 bits) may be used to indicate one of less than seven TDD configurations for another group of CCs. The payload of the DCI format 1C may be utilized in this way, such that some portions of the DCI format 1C may be used for indicator(s) of one bit length, and other portions of the DCI format 1C may be used for indicator(s) of another bit length. Then, for example, the UE may determine that a particular portion of the DCI format 1C is a 3-bit indicator to indicate one of seven TDD configurations and another portion of the DCI format 1C is an indicator of less than 3 bits to indicate one of less than seven TDD configurations. The DCI format 1C may be configured by a base station to include the above indicators.

According to one aspect, for a given CC, a configuration is selected from less than a particular number of TDD configurations (e.g., fewer than all seven configurations of TABLE 1) as a part of eIMTA operation. For example, as described earlier with reference to TABLE 1, configurations corresponding to the indices 0, 1, 2, and 6 have a switch-point periodicity of 5 msec. If a CC (e.g., a cell) may perform eIMTA using only the configurations having a switch-point periodicity of 5 msec, then an indicator having a length of 2 bits (e.g., instead of 3 bits) would be sufficient to cover the four possible configurations for such a CC. Similarly, as also described earlier with reference to TABLE 1, configurations corresponding to the indices 3, 4, and 5 have a switch-point periodicity of 10 msec. If a CC (e.g., a cell) may perform eIMTA using only the configurations having a switch-point periodicity of 10 msec, then an indicator having a length of only 2 bits (e.g., instead of 3 bits) would be sufficient to cover the three possible configurations for such a CC.

In another aspect, a 2-bit indicator or a 1-bit indicator may be sufficient to cover TDD configurations in another scenario. As described earlier, certain subframes may not be subject to dynamic adaptation of transmission directions. The subframes that are not subject to dynamic adaptation include subframes that are for DL in a TDD configuration as indicated in SIB 1, and subframes that are for UL in a DL HARQ reference configuration. Hence, some subframes should remain as DL frames or UL frames based on the SIB 1 and the DL HARQ reference configuration. Therefore, based on the SIB 1 and the DL HARQ reference configuration, a number of possible TDD configurations may be less than seven TDD configurations.

For example, the TDD configuration indicated by SIB 1 may be configuration 0 (DSUUUDSUUU), and the DL HARQ reference configuration may be configuration 2 (DSUDDDSUDD). The subframes that are for DL in configuration 0 (the TDD configuration indicated by SIB 1) are subframes 0 and 5. The subframes that are for UL in configuration 2 (the DL HARQ reference configuration) are subframes 2 and 7. Therefore, subframes 0 and 5 may not be subject to dynamic adaptation and should remain as DL subframes during eIMTA operation. Also, subframes 2 and 7 may not be subject to dynamic adaptation and should remain as UL subframes during eIMTA operation. Hence, in this example, based on the SIB 1 and the DL HARQ reference configuration, the condition for available TDD configurations is that subframes 0 and 5 are DL subframes and subframes 2 and 7 are UL subframes. With reference to TABLE 1, the only configurations that satisfy the noted condition (other than configurations 0 and 2) are configuration 1 (DSUUDDSUUD) and configuration 6 (DSUUUDSUUD). As a result, only 4 configurations (configurations 0, 2, 1 and 6) are available for this particular group of CCs. To cover these four configurations, a 2-bit indicator would be sufficient.

As described above, according to aspects of the disclosure, not all CCs are assigned a 3-bit indicator for eIMTA operation. For example, a 2-bit indicator may be sufficient for at least one CC or at least one group of CCs. Accordingly, instead of a 3-bit indicator, an indicator having a length of less than three bits may be used for at least one group of CCs.

Hence, according to various aspects of the disclosure, when the UE receives DCI format 1C, the UE may determine that different portions of the DCI format 1C payload correspond to indicators of particular bit lengths, and then may determine the TDD configurations based on the indicators for corresponding groups of CCs. Thus, in one aspect, for example, the UE may determine that, in the payload (e.g., 15 bits) of the DCI format 1C, the first several bits (e.g., the first 9 bits) are used as 3-bit indicators to respectively indicate TDD configurations of one or more groups of CCs, and the remaining bits are used as 2-bit indicators to indicate TDD configurations of the remaining groups of CCs. In another aspect, for example, the UE may determine that, in the payload (e.g., 15 bits) of the DCI format 1C, the first several bits (e.g., the first 9 bits) are used as 3-bit indicators to respectively indicate TDD configurations of one or more groups of CCs, and various combinations of the remaining bits are used to indicate different combinations of TDD configurations of the remaining groups of CCs.

One aspect of the disclosure employs information explicitly provided by RRC configuration. For example, the UE may determine that DCI (e.g., DCI format 1C) includes an indicator for eIMTA, where the indicator indicates a TDD UL-DL configuration for a CC (e.g., at least a first CC) or a group of CCs. Generally, the UE may determine that DCI includes several indicators for TDD UL-DL configurations for multiple CCs (or multiple groups of CCs). Based on RRC configuration information received at the UE, the UE may interpret the DCI as including an indicator for a particular TDD UL-DL configuration. In particular, the RRC configuration information may specify (e.g., explicitly specify) at least a bit length of each of indicators corresponding to respective portions of the DCI payload. According to a first approach of this aspect, the RRC configuration information may further specify TDD uplink-downlink configurations for groups of CCs respectively indicated by the bit values of the indicator, and a correspondence between each the indicators and a corresponding group of CCs. According to a second approach of this aspect, the RRC configuration information may further specify combinations of TDD uplink-downlink configurations for multiple groups of CCs respectively indicated by various combinations of bit values of an indicator in the DCI, and a correspondence between the indicator and the multiple groups of CCs.

For example, a UE may be configured with 16 CCs, where the CCs collectively belong to six bands (or six groups). As described earlier, the size of the DCI format 1C (e.g., the size of the corresponding payload) is 15 bits when the system bandwidth is 20 MHz. The 15-bit payload may be utilized as follows, in order to indicate the TDD configurations for the six groups of CCs.

According to one example of the first approach, there may be six groups of CCs, where each group of the first three groups of CCs uses a 3-bit indicator and each group of the second three groups of CCs uses a 2-bit indicator. RRC configuration information received by the UE may specify that the length of each of the first three indicators in the DCI format 1C is 3 bits and that the length of each of the remaining three indicators in the DCI format 1C is 2 bits. Therefore, using the 3-bit indicator, a configuration out of seven possible configurations (e.g., the seven TDD configurations of TABLE 1) may be indicated for each of these first three groups. For each of the remaining three groups of CCs, a 2-bit indicator may be used to indicate a configuration out of three or four possible configurations. For example, a 2-bit indicator may be used because each of the remaining three groups performs eIMTA using only one of the four TDD configurations (of TABLE 1) that have a switch-point periodicity of 5 msec (or one of the three TDD configurations that have a switch-point periodicity of 10 msec). Accordingly, in this example, the 15-bit payload of the DCI format 1C includes three 3-bit indicators and three 2-bit indicators, collectively for six groups of CCs.

According to one example of the second approach, there may be six groups of CCs, where each group of the first three groups of CCs uses a 3-bit indicator and the second three groups of CCs use a 6-bit indicator. RRC configuration information received by the UE may specify that the length of each of the first three indicators in the DCI format 1C is 3 bits and that the length of the remaining indicator is 6 bits. Therefore, using the 3-bit indicator, a configuration out of seven possible configurations (e.g., the seven configurations of TABLE 1) may be indicated for each of these first three groups. For the remaining three groups of CCs, a 6-bit indicator may be used, such that the 6-bit indicator is shared by the remaining three groups. For example, the 6-bit indicator may define up to 64 (decimal) values, where each value defines a particular combination of TDD configurations for the remaining three groups. For example, a decimal value of 1 may define a combination (e.g., combination 1) according to which configurations 2, 3 and 4 (see TABLE 1) are indicated for CC groups 4, 5 and 6, respectively. Accordingly, the 15-bit payload includes three 3-bit indicators and one 6-bit indicator, collectively for six groups of CCs.

Another aspect of the disclosure employs information that is implicitly derived based on an RRC configuration. For example, the UE may determine that DCI (e.g., DCI format 1C) includes an indicator for eIMTA, where the indicator indicates a TDD UL-DL configuration for a CC (e.g., at least a first CC) or a group of CCs. Generally, the UE may determine that DCI includes several indicators for TDD UL-DL configurations for multiple CCs (or multiple groups of CCs). During RRC configuration signaling, SIB 1 and DL HARQ reference configuration may be exchanged between the UE and the base station. As discussed above, subframes that are for DL in a TDD configuration indicated in SIB 1 may not be subject to dynamic adaptation, and subframes that are for UL in a reference configuration for DL HARQ may not be subject to dynamic adaptation. Based on a SIB 1 corresponding to the CC and a DL HARQ reference configuration, the UE may determine that a portion of the DCI includes an indicator of a particular bit length.

For example, for a particular CC(s) (or cell), the TDD configuration indicated by SIB 1 may be configuration 0 (DSUUUDSUUU), and the DL HARQ reference configuration may be configuration 2 (DSUDDDSUDD). As described earlier, in this case, subframes 0 and 5 should remain as DL subframes, and subframes 2 and 7 should remain as UL subframes during eIMTA operation. Thus, as described earlier, accordingly, only 4 configurations are possible in this example: configurations 0, 2, 1 and 6. To cover these four possible configurations, a 2-bit indicator would be sufficient. Based on the TDD configuration indicated by SIB 1 and the DL HARQ reference configuration, the UE is able to interpret (or determine) that the DCI will carry a 2-bit indicator for this particular CC(s) (or cell), where the 2-bit indicator indicates one of the four possible configurations.

As another example, for a particular CC(s) (or cell), the TDD configuration indicated by SIB 1 may be configuration 1 (DSUUDDSUUD), and the DL HARQ reference configuration may be configuration 2 (DSUDDDSUDD). The subframes that are for DL in configuration 1 (the TDD configuration indicated by SIB 1) are subframes 0, 4, 5 and 9. The subframes that are for UL in configuration 2 (the DL HARQ reference configuration) are subframes 2 and 7. Therefore, subframes 0, 4, 5 and 9 may not be subject to dynamic adaptation, and should remain as DL subframes during eIMTA operation. Also, subframes 2 and 7 may not be subject to dynamic adaptation, and should remain as UL subframes during eIMTA operation. With reference to TABLE 1, no additional configurations satisfy the noted conditions (other than configurations 1 and 2). As a result, two configurations (configurations 1 and 2) are available for this particular CC. To cover these two possible configurations, a 1-bit indicator would be sufficient. Based on the TDD configuration indicated by SIB 1 and the DL HARQ reference configuration, the UE is able to interpret that the DCI will carry a 1-bit indicator for this particular CC(s) (or cell).

As another example, for a particular CC (or cell), the TDD configuration indicated by SIB 1 may be configuration 0 (DSUUUDSUUU), and the DL HARQ reference configuration may be configuration 5 (DSUDDDDDDD). The subframes that are for DL in configuration 0 (the TDD configuration indicated by SIB 1) are subframes 0 and 5. The subframe that is for UL in configuration 5 (the DL HARQ reference configuration) is subframe 2. Therefore, subframes 0 and 5 may not be subject to dynamic adaptation, and should remain as DL subframes during eIMTA operation. Also, subframe 2 may not be subject to dynamic adaptation, and should remain as an UL subframe during eIMTA operation. With reference to TABLE 1, all of the remaining configurations satisfy the noted conditions. As a result, all seven TDD configurations (of TABLE 1) are possible. To cover these seven possible configurations, a 3-bit indicator would be sufficient. Based on the TDD configuration indicated by SIB 1 and the DL HARQ reference configuration, the UE is able to interpret that the DCI will carry a 3-bit indicator for this particular CC (or cell).

As another example, for a CC (or cell), a set of possible TDD configurations can be more than 7. For instance, a cell may support, in addition to the existing 7 TDD configurations (shown in Table 1), one or more new TDD configurations such as a TDD configuration with all DL subframes and a TDD configuration with 9 DL subframes and one special subframe may be additional possible TDD configurations, resulting in a total of up to 9 TDD configurations. As a result, a 4-bit indicator may be necessary (e.g., to indicate one of 9 possible TDD configurations). Thus, in one example, for a first CC, a 4-bit indicator may be used to support 9 TDD configurations, whereas for another CC, a 3-bit indicator may be used to support the 7 TDD configurations. Alternatively, a 3-bit indicator (or an indicator with a shorter bit length) can be used to indicate a subset of 9 possible TDD configurations. In one example, compared with a second CC which may only support the existing 7 TDD configurations (shown in Table 1), the 3-bit indicator for the first CC may have different interpretations. For example, a 3-bit value of 110 in a 3-bit indicator for the second CC may indicate a TDD configuration #6, while a 3-bit value of 110 in a 3-bit indicator for the first CC may indicate a TDD configuration of all DL subframes. Such CC-dependent (or group-CC-dependent) indicator interpretation may be provided by an RRC configuration.

Based on the examples that have been described above, in a single DCI format 1C, different groups of CCs may be associated with indicators with different sizes for eIMTA indication. For example, in a single DCI format 1C, one group of CCs may be associated with a 2-bit indicator, another group of CCs may be associated with a 1-bit indicator, and yet another group of CCs may be associated with a 3-bit indicator.

The DL HARQ reference configuration that may be used to implicitly indicate TDD configurations is typically UE-specific. However, eIMTA indication is typically common to UEs that monitor the same eIMTA indicator (e.g., an indicator to indicate a TDD configuration). According to one aspect, in order to ensure proper operations, the DL HARQ reference configuration is also common to UEs that monitor the same eIMTA indicator.

Under dual-PUCCH in CA, a UE is connected to a single eNB. This is unlike dual-connectivity, in which a UE is connected to two eNBs. Under dual-PUCCH, it may be likely that the UE may not monitor the CSS on the pScell. For example, the UE may not monitor the cell that carries the second PUCCH, in addition to monitoring the PUCCH on the PCell.

It may also be likely that cross-carrier scheduling between the PCG (which includes the PCell) and the SCG (which includes the pSCell) in CA is not allowed. Therefore, it may be likely that eIMTA operation for the SCG relies on the CSS on the Pcell. As a result, even with dual-PUCCH, eIMTA operation may be similar to eIMTA operation based on a single PUCCH, such that the UE monitors only one CSS.

According to one aspect, if a UE is not configured with eIMTA for at least one CC in the SCG, then the UE may not monitor the CSS on the pScell. If the UE is configured with eIMTA for at least one CC in the SCG, then the UE is configured to monitor the CSS on the pScell. In this situation, a DCI format 1C that is scrambled by eIMTA-RNTI for eIMTA operation on at least one CC of the SCG may be transmitted on the CSS of the pScell. This would then alleviate the constraint of monitoring a single CSS for eIMTA.

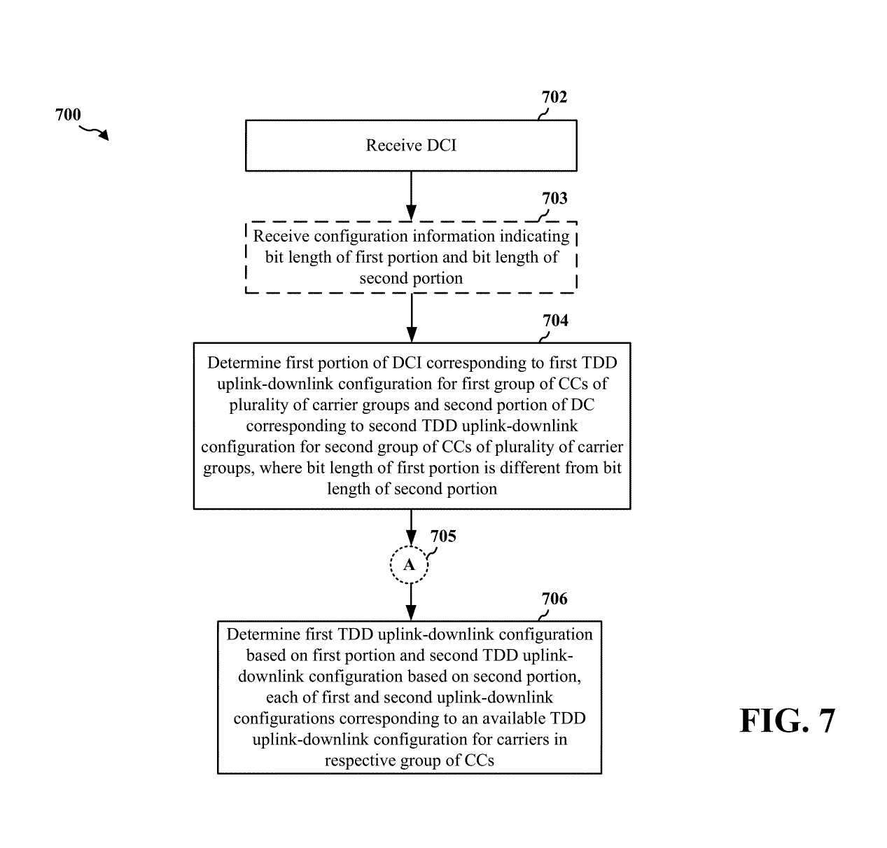

FIG. 7 is a flowchart 700 of a method of wireless communication. The method may be performed by a UE (e.g., the UE 350, the apparatus 902/902′).

At 702, the UE receives DCI. For example, as discussed supra, the UE may receive the DCI format 1C (e.g., from an eNB), and may perform TDD UL-DL configurations based on the indication provided in the DCI format 1C.

At 703, in an aspect, the UE may receive configuration information indicating the bit length of the first portion and the bit length of the second portion. For example, as discussed supra, the RRC configuration information may specify (e.g., explicitly specify) at least a bit length of each of indicators corresponding to respective portions of the DCI payload.

At 704, the UE determines a first portion of the DCI corresponding to a first TDD uplink-downlink configuration for a first group of CCs of a plurality of carrier groups and a second portion of the DCI corresponding to a second TDD uplink-downlink configuration for a second group of CCs of the plurality of carrier groups, where a bit length of the first portion is different from a bit length of the second portion. For example, as discussed supra, when the UE receives DCI format 1C, the UE may determine that different portions of the DCI format 1C payload correspond to indicators of particular bit lengths, and then may determine the TDD configurations based on the indicators for corresponding groups of CCs. For example, as discussed supra, the UE may determine that, in the payload (e.g., 15 bits) of the DCI format 1C, the first several bits are used as 3-bit indicators to respectively indicate TDD configurations of one or more groups of CCs, and the remaining bits are used as 2-bit indicators to indicate TDD configurations of the remaining groups of CCs.

As discussed above, in an aspect, the UE may receive configuration information indicating the bit length of the first portion and the bit length of the second portion. As discussed supra, for example, the RRC configuration information may specify (e.g., explicitly specify) at least a bit length of each of indicators corresponding to respective portions of the DCI payload. In such an aspect, the configuration information defines a mapping between the first portion and the first TDD uplink-downlink configuration for the first group of CCs and a mapping between the second portion and the second TDD uplink-downlink configuration for the second group of CCs. According to one approach, the RRC configuration information may further specify TDD uplink-downlink configurations for groups of CCs respectively indicated by the bit values of the indicator, and a correspondence between each the indicators and a corresponding group of CCs. For example, as discussed supra, a configuration out of seven possible configurations (e.g., the seven TDD configurations of TABLE 1) may be indicated for each of these first three groups, and for each of the remaining three groups of CCs, a 2-bit indicator may be used to indicate a configuration out of three or four possible configurations.

In such an aspect, the first TDD uplink-downlink configuration may be indicated by a combination of TDD uplink-downlink configurations defined by at least the first portion, based on the configuration information. For example, as discussed supra, the UE may determine that, in the payload (e.g., 15 bits) of the DCI format 1C, the first several bits are used as 3-bit indicators to respectively indicate TDD configurations of one or more groups of CCs, and various combinations of the remaining bits are used to indicate different combinations of TDD configurations of the remaining groups of CCs. For example, as discussed supra, each group of the first three groups of CCs uses a 3-bit indicator, and for the remaining three groups of CCs, a 6-bit indicator may be used, such that the 6-bit indicator may define up to 64 (decimal) values, where each value defines a particular combination of TDD configurations for the remaining three groups.

In another aspect, the determining the first portion of the DCI and the second portion of the DCI may be based on at least one of a SIB message or a HARQ reference configuration of the UE. For example, as discussed supra, based on a SIB 1 corresponding to the CC and a DL HARQ reference configuration, the UE may determine that a portion of the DCI includes an indicator of a particular bit length.

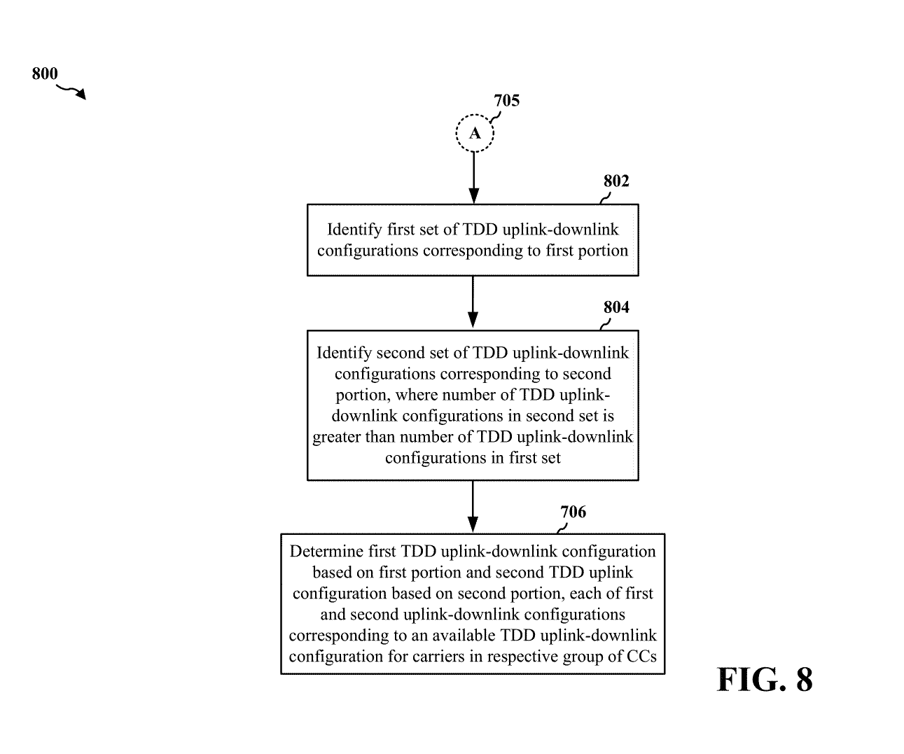

At 705, the UE may perform additional features as described infra in more detail in reference to FIG. 8.

At 706, the UE determines the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs. For example, as discussed supra, when the UE receives DCI format 1C, the UE may determine which portions of the DCI format 1C payload are for indicators of particular bit lengths, and then may determine the TDD configurations based on the indicators for corresponding groups of CCs.

In an aspect, the bit length of the first portion may be less than 3 bits or greater than 3 bits. In an aspect, the bit length of the second portion may be 3 bits. In an aspect, the first group of CCs may be in a different band with respect to the second group of CCs. In an aspect, the plurality of groups may include more than five groups of CCs. For example, as discussed supra, using the 3-bit indicator, a configuration out of seven possible configurations (e.g., the seven TDD configurations of TABLE 1) may be indicated for each of these first three groups, and for each of the remaining three groups of CCs, a 2-bit indicator may be used to indicate a configuration out of three or four possible configurations. Thus, as discussed supra, in this example, the 15-bit payload of the DCI format 1C includes three 3-bit indicators and three 2-bit indicators, collectively for six groups of CCs.

In an aspect, where the first group of CCs includes a first CC and the second group of CCs includes a second CC, a CSS on the second CC is monitored if the second CC is activated for the UE and the CSS on the second CC is not monitored if the second CC is not activated for the UE. For example, as discussed supra, if a UE is not configured with eIMTA for at least one CC in the SCG, then the UE is not configured to monitor the CSS on the pScell. For example, as discussed supra, if the UE is configured with eIMTA for at least one CC in the SCG, then the UE is configured to monitor the CSS on the pScell.

FIG. 8 is a flowchart 800 of a method of wireless communication, expanding from the flowchart 700 of FIG. 7. The method may be performed by a UE (e.g., the UE 350, the apparatus 902/902′). In the aspect of the flowchart 800 of FIG. 8, the bit length of the second portion is larger than the bit length of the first portion. For example, a discussed supra, in the DCI format 1C, although 3 bits may be used to indicate one of seven TDD configurations for one group of CCs, a different number of bits (e.g., less than 3 bits) may be used to indicate one of less than seven TDD configurations.

At 705, the UE continues from 705 of FIG. 7. At 802, the UE identifies a first set of TDD uplink-downlink configurations corresponding to the first portion. At 804, the UE identifies a second set of TDD uplink-downlink configurations corresponding to the second portion, where a number of TDD uplink-downlink configurations in the second set is greater than a number of TDD uplink-downlink configurations in the first set. For example, as discussed supra, for example, the UE may determine that a particular portion of the DCI format 1C is a 3 bit indicator to indicate one of seven TDD configurations and another portion of the DCI format 1C is an indicator of less than 3 bits to indicate one of less than seven TDD configurations. After 804, the UE may proceed to 706, where the UE determines the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs, as discussed above.

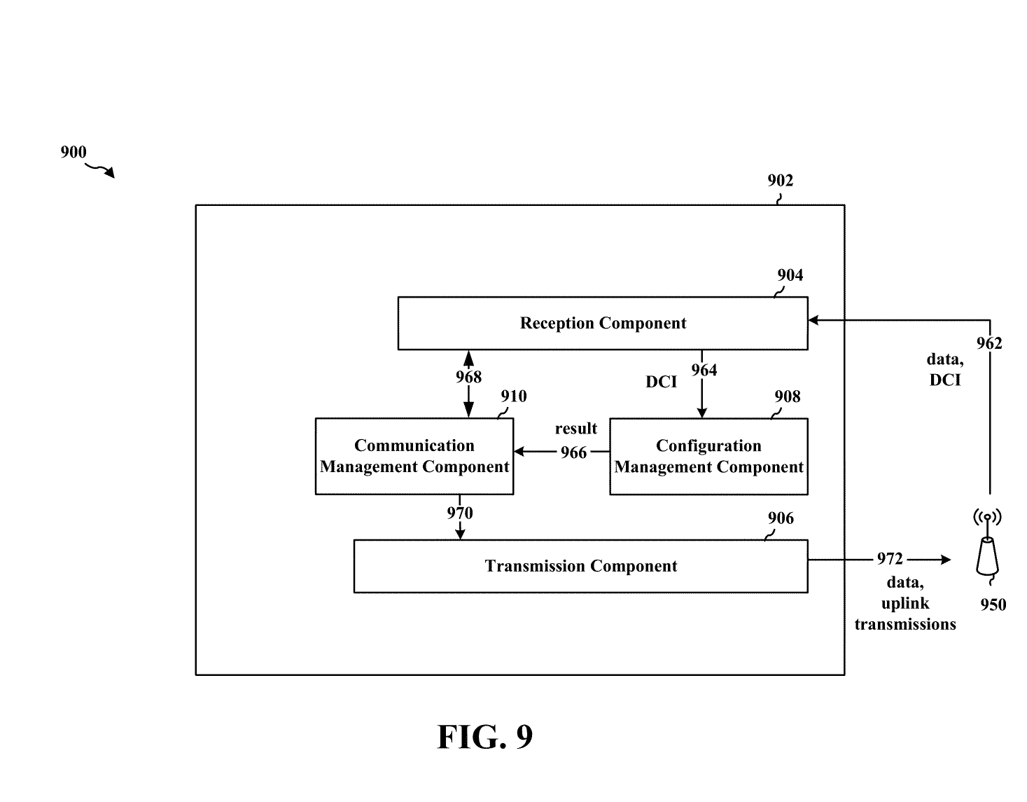

FIG. 9 is a conceptual data flow diagram 900 illustrating the data flow between different means/components in an exemplary apparatus 902. The apparatus may be a UE. The apparatus includes a reception component 904, a transmission component 906, a configuration management component 908, and a communication management component 910.

The reception component 904 receives DCI (e.g., from a base station 950), at 962. The reception component 904 may forward the DCI to the configuration management component 908, at 964.

The configuration management component 908 determines a first portion of the DCI corresponding to a first TDD uplink-downlink configuration for a first group of CCs of a plurality of carrier groups (e.g., groups of aggregated CCs) and a second portion of the DCI corresponding to a second TDD uplink-downlink configuration for a second group of CCs of the plurality of carrier groups, where a bit length of the first portion is different from a bit length of the second portion.

In an aspect, the reception component 904 may receive (e.g., from the base station 950) configuration information indicating the bit length of the first portion and the bit length of the second portion, at 962. The reception component 904 may forward the configuration information to the configuration management component 908, at 964. In such an aspect, the configuration information may define a mapping between the first portion and the first TDD uplink-downlink configuration for the first group of CCs and a mapping between the second portion and the second TDD uplink-downlink configuration for the second group of CCs. In such an aspect, the first TDD uplink-downlink configuration may be indicated by a combination of TDD uplink-downlink configurations defined by at least the first portion, based on the configuration information.

In another aspect, the configuration management component 908 determines the first portion of the DCI and the second portion of the DCI is based on at least one of a SIB message or a HARQ reference configuration of the UE.

In an aspect where the bit length of the second portion is larger than the bit length of the first portion, the configuration management component 908 may identify a first set of TDD uplink-downlink configurations corresponding to the first portion, and identify a second set of TDD uplink-downlink configurations corresponding to the second portion, where a number of TDD uplink-downlink configurations in the second set is greater than a number of TDD uplink-downlink configurations in the first set

The configuration management component 908 determines the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs. The configuration management component 908 may forward the results of the determination of the TDD uplink-downlink configurations to the communication management component 910, at 966. Based on the results of the determination, the communication management component 910 may manage the reception component 904 and the transmission component for communication with the base station 950, at 968, 970, 972 and 962.

In an aspect, the bit length of the first portion may be less than 3 bits or greater than 3 bits. In an aspect, the bit length of the second portion may be 3 bits. In an aspect, the first group of CCs may be in a different band with respect to the second group of CCs. In an aspect, the plurality of carrier groups may include more than five groups of CCs.

In an aspect, where the first group of CCs includes a first CC and the second group of CCs includes a second CC, a CSS on the second CC is monitored if the second CC is activated for the UE and the CSS on the second CC is not monitored if the second CC is not activated for the UE.

The apparatus may include additional components that perform each of the blocks of the algorithm in the aforementioned flowcharts of FIGS. 7 and 8. As such, each block in the aforementioned flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

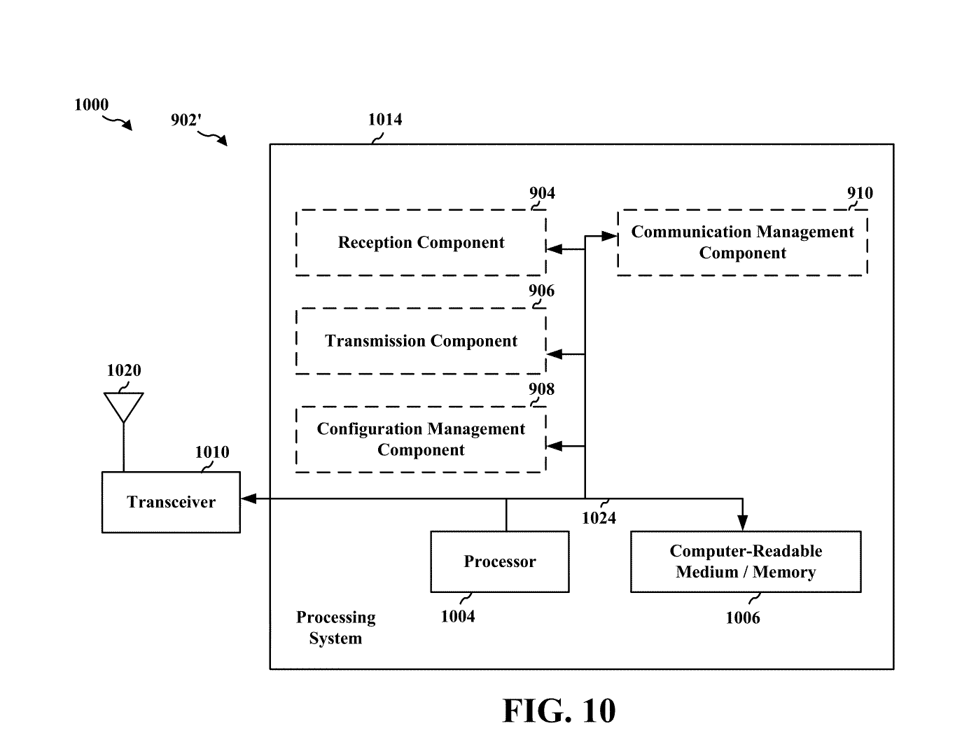

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, 910, and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 906, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908, 910. The components may be software components running in the processor 1004, resident/stored in the computer readable medium/memory 1006, one or more hardware components coupled to the processor 1004, or some combination thereof. The processing system 1014 may be a component of the UE 350 and may include the memory 360 and/or at least one of the TX processor 368, the RX processor 356, and the controller/processor 359.

In one configuration, the apparatus 902/902′ for wireless communication includes means for receiving DCI, means for determining a first portion of the DCI corresponding to a TDD uplink-downlink configuration for a first group of CCs of a plurality of carrier groups and a second portion of the DCI corresponding to a second TDD uplink-downlink configuration for a second group of CCs of the plurality of carrier groups, where a bit length of the first portion is different from a bit length of the second portion, and means for determining the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs. In an aspect, where the bit length of the second portion is larger than the bit length of the first portion, the apparatus 902/902′ further includes means for identifying a first set of TDD uplink-downlink configurations corresponding to the first portion, and means for identifying a second set of TDD uplink-downlink configurations corresponding to the second portion, where a number of TDD uplink-downlink configurations in the second set is greater than a number of TDD uplink-downlink configurations in the first set. In an aspect, the apparatus 902/902′ may further includes means for receiving configuration information indicating the bit length of the first portion and the bit length of the second portion. In such an aspect, the configuration information defines a mapping between the first portion and the first TDD uplink-downlink configuration for the first group of CCs and a mapping between the second portion and the second TDD uplink-downlink configuration for the second group of CCs. In such an aspect, the first TDD uplink-downlink configuration is indicated by a combination of TDD uplink-downlink configurations defined by at least the first portion, based on the configuration information. In an aspect, the means for determining the first portion of the DCI and the second portion of the DCI is configured to determine the first portion of the DCI and the second portion of the DCI based on at least one of a SIB message or a HARQ reference configuration of the UE.

The aforementioned means may be one or more of the aforementioned components of the apparatus 902 and/or the processing system 1014 of the apparatus 902′ configured to perform the functions recited by the aforementioned means. As described supra, the processing system 1014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

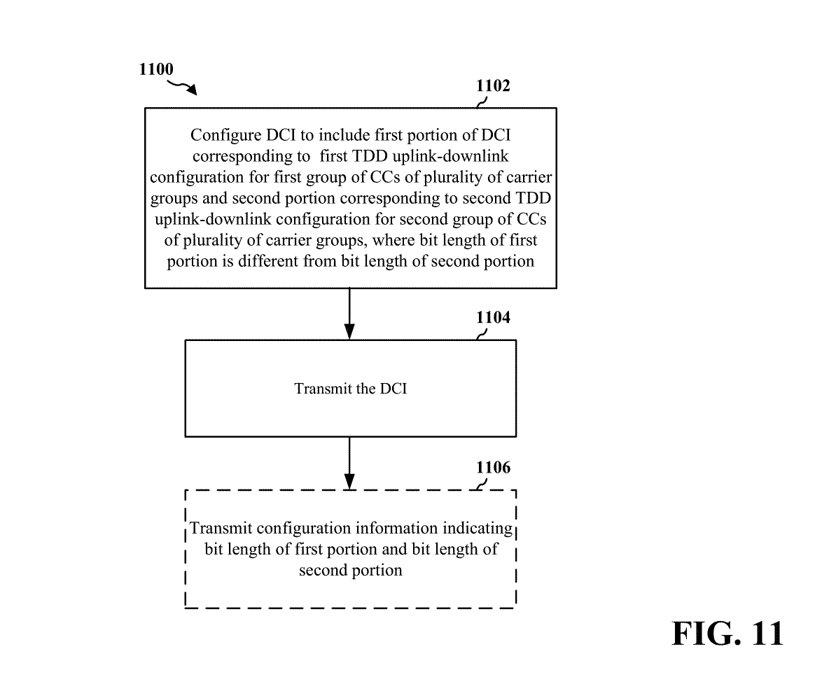

FIG. 11 is a flowchart 1100 of a method of wireless communication. The method may be performed by an eNB (e.g., the eNB 310, the apparatus 1202/1202′).

At 1102, the eNB configures DCI to include a first portion of the DCI corresponding to a TDD uplink-downlink configuration for a first group of CCs of a plurality of carrier groups (e.g., groups of aggregated CCs) and a second portion corresponding to a second TDD uplink-downlink configuration for a second group of CCs of the plurality of carrier groups, where a bit length of the first portion is different from a bit length of the second portion, each of the first and second uplink-downlink configurations corresponding to an available TDD uplink-downlink configuration for carriers in a respective group of CCs. For example, as discussed supra, when the UE receives DCI format 1C, the UE may determine different portions of the DCI format 1C payload are for indicators of particular bit lengths, and then may determine the TDD configurations based on the indicators for corresponding groups of CCs. The DCI format 1C may be configured by a base station to include the above indicators.

At 1104, the eNB transmits the DCI to a UE. For example, as discussed supra, the UE may receive the DCI format 1C (e.g., from an eNB), and may perform TDD UL-DL configurations based on the indication provided in the DCI format 1C.

In an aspect, at 1106, the eNB may transmit configuration information indicating the bit length of the first portion and the bit length of the second portion. For example, as discussed supra, the RRC configuration information may specify (e.g., explicitly specify) at least a bit length of each indicator (e.g., each indicator corresponding to a portion in the DCI), TDD uplink-downlink configurations respectively indicated by the bit value(s) of the indicator, and a correspondence between the indicator and a corresponding CC. In such an aspect, the configuration information may define a mapping between the first portion and the first TDD uplink-downlink configuration for the first group of CCs and a mapping between the second portion and the second TDD uplink-downlink configuration for the second group of CCs. According to one approach, the RRC configuration information may further specify TDD uplink-downlink configurations for groups of CCs respectively indicated by the bit values of the indicator, and a correspondence between each the indicators and a corresponding group of CCs. For example, as discussed supra, a configuration out of seven possible configurations (e.g., the seven TDD configurations of TABLE 1) may be indicated for each of these first three groups, and for each of the remaining three groups of CCs, a 2-bit indicator may be used to indicate a configuration out of three or four possible configurations. In such an aspect, the first TDD uplink-downlink configuration may be indicated by a combination of TDD uplink-downlink configurations defined by at least the first portion, based on the configuration information. For example, as discussed supra, the UE may determine that, in the payload (e.g., 15 bits) of the DCI format 1C, the first several bits are used as 3-bit indicators to respectively indicate TDD configurations of one or more groups of CCs, and various combinations of the remaining bits are used to indicate different combinations of TDD configurations of the remaining groups of CCs. For example, as discussed supra, each group of the first three groups of CCs uses a 3-bit indicator, and for the remaining three groups of CCs, a 6-bit indicator may be used, such that the 6-bit indicator may define up to 64 (decimal) values, where each value defines a particular combination of TDD configurations for the remaining three groups

In another aspect, the first portion of the DCI and the second portion of the DCI may be based on at least one of a SIB message or a HARQ reference configuration of the UE. For example, as discussed supra, based on a SIB 1 corresponding to the CC and a DL HARQ reference configuration, the UE may determine that a portion of the DCI includes an indicator of a particular bit length.

In an aspect where the bit length of the second portion is larger than the bit length of the first portion, the first portion may correspond to a first set of TDD uplink-downlink configurations and the second portion may correspond to a second set of TDD uplink-downlink configurations. In such an aspect, a number of TDD uplink-downlink configurations in the second set is greater than a number of TDD uplink-downlink configurations in the first set. For example, a discussed supra, in the DCI format 1C, although 3 bits may be used to indicate one of seven TDD configurations for one group of CCs, a different number of bits (e.g., less than 3 bits) may be used to indicate one of less than seven TDD configurations. For example, as discussed supra, for example, the UE may determine that a particular portion of the DCI format 1C is a 3 bit indicator to indicate one of seven TDD configurations and another portion of the DCI format 1C is an indicator of less than 3 bits to indicate one of less than seven TDD configurations.

In an aspect, the bit length of the first portion may be less than 3 bits or greater than 3 bits. In an aspect, the bit length of the second portion may be 3 bits. In an aspect, the first group of CCs may be in a different band with respect to the second group of CCs. In an aspect, the plurality of carrier groups may include more than five groups of CCs. For example, as discussed supra, using the 3-bit indicator, a configuration out of seven possible configurations (e.g., the seven TDD configurations of TABLE 1) may be indicated for each of these first three groups, and for each of the remaining three groups of CCs, a 2-bit indicator may be used to indicate a configuration out of three or four possible configurations. Thus, as discussed supra, in this example, the 15-bit payload of the DCI format 1C includes three 3-bit indicators and three 2-bit indicators, collectively for six groups of CCs.

In an aspect, where the first group of CCs includes a first CC and the second group of CCs includes a second CC, a CSS on the second CC is monitored if the second CC is activated for the UE and the CSS on the second CC is not monitored if the second CC is not activated for the UE. For example, as discussed supra, if a UE is not configured with eIMTA for at least one CC in the SCG, then the UE is not configured to monitor the CSS on the pScell. For example, as discussed supra, if the UE is configured with eIMTA for at least one CC in the SCG, then the UE is configured to monitor the CSS on the pScell.

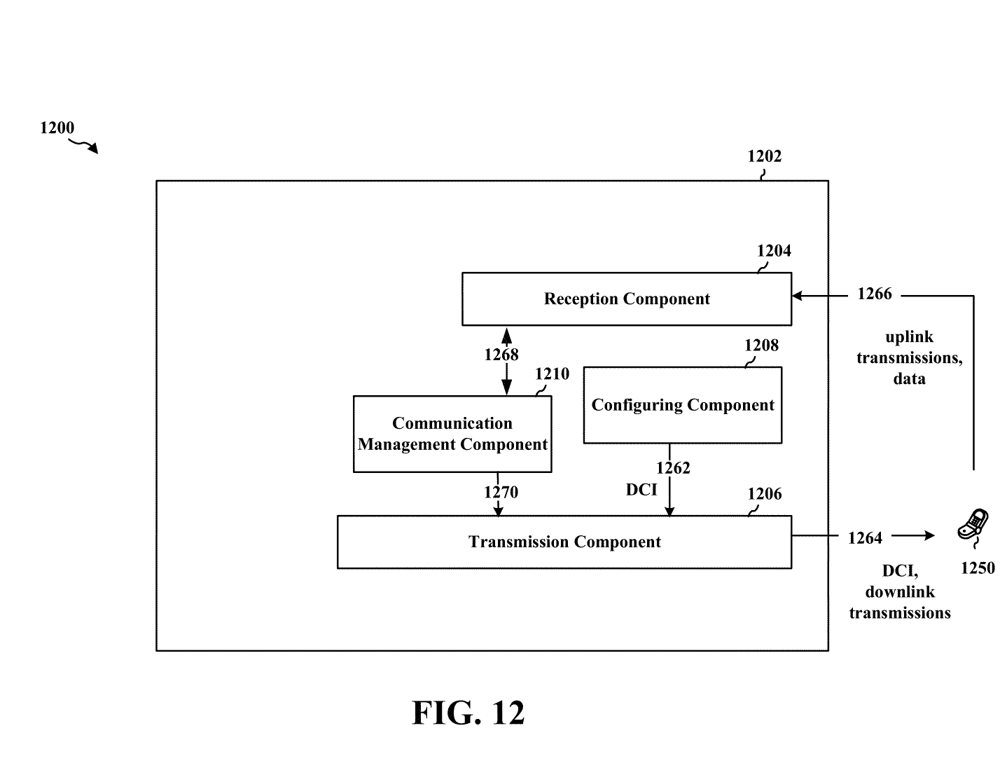

FIG. 12 is a conceptual data flow diagram 1200 illustrating the data flow between different means/components in an exemplary apparatus 1202. The apparatus may be an eNB. The apparatus includes a reception component 1204, a transmission component 1206, and a configuring component 1208.

The configuring component 1208 configures DCI to include a first portion of the DCI corresponding to a TDD uplink-downlink configuration for a first group of CCs of a plurality of carrier groups and a second portion corresponding to a second TDD uplink-downlink configuration for a second group of CCs of the plurality of carrier groups, where a bit length of the first portion is different from a bit length of the second portion. Each of the first and second uplink-downlink configurations corresponds to an available TDD uplink-downlink configuration for carriers in a respective group of CCs. The configuring component 1208 sends the configured DCI to the transmission component 1206, at 1262.

The transmission component 1206 transmits the DCI to a UE 1250, at 1264.

In an aspect, the transmission component 1206 may transmit configuration information indicating the bit length of the first portion and the bit length of the second portion, at 1264, to the UE 1250. In such an aspect, the configuration information may define a mapping between the first portion and the first TDD uplink-downlink configuration for the first group of CCs and a mapping between the second portion and the second TDD uplink-downlink configuration for the second group of CCs. In such an aspect, the first TDD uplink-downlink configuration may be indicated by a combination of TDD uplink-downlink configurations defined by at least the first portion, based on the configuration information.

In another aspect, the first portion of the DCI and the second portion of the DCI may be based on at least one of a SIB message or a HARQ reference configuration of the UE 1250.

In an aspect where the bit length of the second portion is larger than the bit length of the first portion, the first portion may correspond to a first set of TDD uplink-downlink configurations and the second portion may correspond to a second set of TDD uplink-downlink configurations. In such an aspect, a number of TDD uplink-downlink configurations in the second set is greater than a number of TDD uplink-downlink configurations in the first set.

In an aspect, the bit length of the first portion may be less than 3 bits or greater than 3 bits. In an aspect, the bit length of the second portion may be 3 bits. In an aspect, the first group of CCs may be in a different band with respect to the second group of CCs. In an aspect, the plurality of carrier groups may include more than five groups of CCs.

In an aspect, where the first group of CCs includes a first CC and the second group of CCs includes a second CC, a CSS on the second CC is monitored if the second CC is activated for the UE and the CSS on the second CC is not monitored if the second CC is not activated for the UE.

The reception component 1204 may receive uplink transmission from the UE 1250, at 1266, and may forward the uplink transmission to the communication management component 1210, at 1268. The communication management component 1210 may also communicate with the transmission component 1270, 1270, to send uplink transmission to the UE 1250.

The apparatus may include additional components that perform each of the blocks of the algorithm in the aforementioned flowcharts of FIG. 9. As such, each block in the aforementioned flowcharts of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

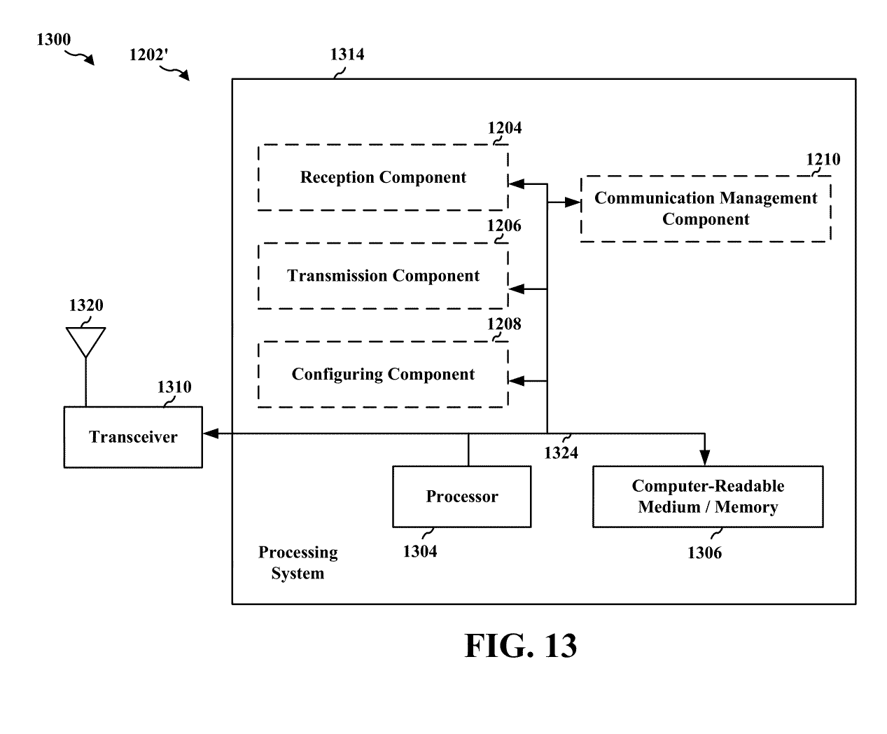

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, 1210, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1206, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system 1314 further includes at least one of the components 1204, 1206, 1208, 1210. The components may be software components running in the processor 1304, resident/stored in the computer readable medium/memory 1306, one or more hardware components coupled to the processor 1304, or some combination thereof. The processing system 1314 may be a component of the eNB 310 and may include the memory 376 and/or at least one of the TX processor 316, the RX processor 370, and the controller/processor 375.

In one configuration, the apparatus 1202/1202′ for wireless communication includes means for configuring DCI to include a first portion of the DCI corresponding to a first TDD uplink-downlink configuration for a first group of CCs of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs, and means for transmitting the DCI to the UE. In an aspect, the apparatus 1202/1202′ further includes means for transmitting configuration information indicating the bit length of the first portion and the bit length of the second portion. In such an aspect, the configuration information defines a mapping between the first portion and the first TDD uplink-downlink configuration for the first group of CCs and a mapping between the second portion and the second TDD uplink-downlink configuration for the second group of CCs. In such an aspect, the first TDD uplink-downlink configuration is indicated by a combination of TDD uplink-downlink configurations defined by at least the first portion, based on the configuration information.

The aforementioned means may be one or more of the aforementioned components of the apparatus 1202 and/or the processing system 1314 of the apparatus 1202′ configured to perform the functions recited by the aforementioned means. As described supra, the processing system 1314 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof′ include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof′ may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication performed by a user equipment (UE), comprising:
receiving downlink control information (DCI); and
determining a first portion of the DCI corresponding to a first time division duplex (TDD) uplink-downlink configuration for a first group of component carriers (CCs) of a plurality of carrier groups and a second portion of the DCI corresponding to a second TDD uplink-downlink configuration for a second group of CCs of the plurality of carrier groups, wherein a bit length of the first portion is different from a bit length of the second portion; and
determining the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs.

2. The method of claim 1, further comprising:
receiving configuration information indicating the bit length of the first portion and the bit length of the second portion.

3. The method of claim 2, wherein the configuration information defines a mapping between the first portion and the first TDD uplink-downlink configuration for the first group of CCs and a mapping between the second portion and the second TDD uplink-downlink configuration for the second group of CCs.

4. The method of claim 2, wherein the first TDD uplink-downlink configuration is indicated by a combination of TDD uplink-downlink configurations defined by at least the first portion, based on the configuration information.

5. The method of claim 1, wherein the determining the first portion of the DCI and the second portion of the DCI is based on at least one of a system information block (SIB) message or a Hybrid Automatic Repeat reQuest (HARD) reference configuration of the UE.

6. The method of claim 1, wherein the plurality of carrier groups comprise more than five groups of CCs.

7. The method of claim 1, wherein:
the first group of CCs includes a first CC;
the second group of CCs includes a second CC;
a common search space (CSS) on the second CC is monitored if the second CC is activated for the UE; and
the CSS on the second CC is not monitored if the second CC is not activated for the UE.

8. The method of claim 1, wherein the bit length of the second portion is 3 bits.

9. The method of claim 8, wherein the first group of CCs is in a different frequency band with respect to the second group of CCs.

10. The method of claim 1, wherein the bit length of the second portion is larger than the bit length of the first portion, the method further comprising:
identifying a first set of TDD uplink-downlink configurations corresponding to the first portion; and
identifying a second set of TDD uplink-downlink configurations corresponding to the second portion, wherein a number of TDD uplink-downlink configurations in the second set is greater than a number of TDD uplink-downlink configurations in the first set.

11. A method of wireless communication performed by a base station, comprising:
configuring downlink control information (DCI) to include a first portion of the DCI corresponding to a first time division duplex (TDD) uplink-downlink configuration for a first group of component carriers (CCs) of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs; and
transmitting the DCI to a user equipment (UE).

12. The method of claim 11, wherein the bit length of the first portion is less than 3 bits or greater than 3 bits.

13. The method of claim 12, wherein the bit length of the second portion is 3 bits.

14. The method of claim 13, wherein the first group of CCs is in a different band with respect to the second group of CCs.

15. The method of claim 11, wherein the bit length of the second portion is larger than the bit length of the first portion,
wherein the first portion corresponds to a first set of TDD uplink-downlink configurations,
wherein the second portion corresponds to a second set of TDD uplink-downlink configurations, and
wherein a number of TDD uplink-downlink configurations in the second set is greater than a number of TDD uplink-downlink configurations in the first set.

16. The method of claim 11, further comprising:
transmitting configuration information indicating the bit length of the first portion and the bit length of the second portion.

17. The method of claim 16, wherein the configuration information defines a mapping between the first portion and the first TDD uplink-downlink configuration for the first group of CCs and a mapping between the second portion and the second TDD uplink-downlink configuration for the second group of CCs.

18. The method of claim 16, wherein the first TDD uplink-downlink configuration is indicated by a combination of TDD uplink-downlink configurations defined by at least the first portion, based on the configuration information.

19. The method of claim 11, wherein the first portion of the DCI and the second portion of the DCI are based on at least one of a system information block (SIB) message or a Hybrid Automatic Repeat reQuest (HARD) reference configuration of the UE.

20. The method of claim 11, wherein the plurality of carrier groups comprises more than five groups of CCs.

21. The method of claim 11, wherein:
the first group of CCs includes a first CC;
the second group of CCs includes a second CC;
a common search space (CS S) on the second CC is monitored if the second CC is activated for the UE; and
the CSS on the second CC is not monitored if the second CC is not activated for the UE.

22. A user equipment (UE) for wireless communication, comprising:
a memory; and
at least one processor coupled to the memory and configured to:
receive downlink control information (DCI);
determining a first portion of the DCI corresponding to a first time division duplex (TDD) uplink-downlink configuration for a first group of component carriers (CCs) of a plurality of carrier groups and a second portion of the DCI corresponding to a second TDD uplink-downlink configuration for a second group of CCs of the plurality of carrier groups, wherein a bit length of the first portion is different from a bit length of the second portion; and
determine the first TDD uplink-downlink configuration based on the first portion and the second TDD uplink-downlink configuration based on the second portion, each of the first and second uplink-downlink configurations corresponding to an available TDD uplink-downlink configuration for carriers in a respective group of CCs.

23. The UE of claim 22, wherein the at least one processor is further configured to:
receive configuration information indicating the bit length of the first portion and the bit length of the second portion.

24. The UE of claim 23, wherein the configuration information defines a mapping between the first portion and the first TDD uplink-downlink configuration for the first group of CCs and a mapping between the second portion and the second TDD uplink-downlink configuration for the second group of CCs.

25. The UE of claim 23, wherein the first TDD uplink-downlink configuration is indicated by a combination of TDD uplink-downlink configurations defined by at least the first portion, based on the configuration information.

26. The UE of claim 22, wherein the at least one processor configured to determine the first portion of the DCI and the second portion of the DCI is configured to determine the first portion of the DCI and the second portion of the DCI is based on at least one of a system information block (SIB) message or a Hybrid Automatic Repeat reQuest (HARD) reference configuration of the UE.

27. The UE of claim 22, wherein:
the first group of CCs includes a first CC;
the second group of CCs includes a second CC;
a common search space (CSS) on the second CC is monitored if the second CC is activated for the UE; and
the CSS on the second CC is not monitored if the second CC is not activated for the UE.

28. The UE of claim 22, wherein the bit length of the second portion is 3 bits, and
wherein the first group of CCs is in a different frequency band with respect to the second group of CCs.

29. The UE of claim 22, wherein the bit length of the second portion is larger than the bit length of the first portion, and wherein the at least one processor is further configured to:
identify a first set of TDD uplink-downlink configurations corresponding to the first portion; and
identify a second set of TDD uplink-downlink configurations corresponding to the second portion, wherein a number of TDD uplink-downlink configurations in the second set is greater than a number of TDD uplink-downlink configurations in the first set.

30. A base station for wireless communication, comprising:
a memory; and
at least one processor coupled to the memory and configured to:
configure downlink control information (DCI) to include a first portion of the DCI corresponding to a first time division duplex (TDD) uplink-downlink configuration for a first group of component carriers (CCs) of a plurality of carrier groups and a second portion corresponding to a second TDD uplink-downlink configuration for a second group of CCs of the plurality of carrier groups, wherein a bit length of the first portion is different from a bit length of the second portion, each of the first and second uplink-downlink configurations corresponding to an available TDD uplink-downlink configuration for carriers in a respective group of CCs; and
transmit the DCI to a user equipment (UE).
